(19) United States
(12) Patent Application Publication
(10) Pub. No.: US 2014/0068060 A1
(43) Pub. Date: Mar. 6, 2014

(54) TIME DATA COLLECTION SYSTEM

(71) Applicants: TOSHIBA TEC KABUSHIKI KAISHA, Tokyo (JP); KABUSHIKI KAISHA TOSHIBA, Tokyo (JP)

(72) Inventors: Masami Takahata, Tokyo-to (JP); Mika Hirama, Tokyo-to (JP); Naoki Watanabe, Tokyo-to (JP); Tomonori Ikumi, Shizuoka-Ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/904,176

(22) Filed: May 29, 2013

(30) Foreign Application Priority Data
Aug. 29, 2012 (JP) 2012-188960

(51) Int. Cl. H04L 12/26

(52) U.S. Cl. CPC H04L 43/10
USPC 709/224

(57) ABSTRACT

In accordance with one embodiment, a time data collection system includes a storage unit, a reception unit configured to receive an information input by a user in a process that the user is looking at and listening to content and a control unit configured to accumulate time data of when the information is received in the reception unit and store the time data in the storage unit.

### CROSS-REFERENCE TO RELATED APPLICATION

This application is based upon and claims the benefit of priority from Japanese Patent Application No. 2012-188960, filed Aug. 29, 2012, the entire contents of which are incorporated herein by reference.

### FIELD

Embodiments described herein relate to a technology acquiring information from a user looking at and listening to content such as a movie and the like.

### BACKGROUND

The screening of movies and the broadcasting of images or music are being carried out every day. In addition, the comment of a user on a looking and listening content can also be acquired through the internet and the like.

### BRIEF DESCRIPTION OF THE DRAWINGS

FIG. 1 is a block diagram illustrating a configuration example of an integral releasing system of the embodiment;

FIG. 2 is a diagram illustrating a hardware configuration example of a server;

FIG. 3 is a flow chart illustrating an example of the integral actions of the releasing system of the embodiment;

FIG. 4 is a flow chart illustrating an example of the acquirement actions of a trigger input time;

FIG. 5 is a flow chart illustrating an action example generating a cutout content provided for an audience;

FIG. 6 is a diagram illustrating a correspondence example of a seat number and a customer ID;

FIG. 7 is a diagram illustrating a correspondence example of a seat number and the number of a trigger input apparatus;

FIG. 8 is a diagram illustrating a correspondence example of a trigger count and a trigger input time;

FIG. 9 is a diagram illustrating an example of totalized information;

FIG. 10 is a diagram illustrating an example of the totalized information according to category.

### DETAILED DESCRIPTION

In accordance with one embodiment, a time data collection system includes a storage unit, a reception unit configured to receive an information input by a user in a process that the user is looking at and listening to content and a control unit configured to accumulate time data of when the information is received in the reception unit and store the time data in the storage unit.

In the present embodiment, for the content being looked and listened by the user, the user utilizes a trigger input apparatus to randomly input trigger information. After the content is looked and listened, in the present embodiment, one portion of the looked and listened content is edited and generated by cutting out based on the input trigger information, and the cutout content is provided for the user.

On the other hand, in the present embodiment, the acquired number of the trigger information is totalized at intervals of time. The totalized information can be utilized as data analyzing the interest of an audience for the content. In addition, in the present embodiment, the totalized information of each decade, gender and area can be acquired from an age, a gender, an address (the information related to the user) and the like which are previously acquired as the customer information.

By providing an edited and generated cutout animation and a static image, the user can expect the capable of carrying out trigger input actively at an interested timing. Thus, the totalized information, with high precision can be also acquired quantitatively.

In the present embodiment, such a case of the looking at and listening to a movie in a cinema is taken for example for description. In addition, in the present embodiment, the “content” refers to the inherent substance or a content object of the information, and in the case of looking and listening in the cinema in the present example, the “content” refers to the information of a released image and sound. The image can be an animation or a static image. In addition, the “looking and listening” indicating either one of the “looking” and the “listening” or both, can also be utilized as the term for only “looking” or “listening”.

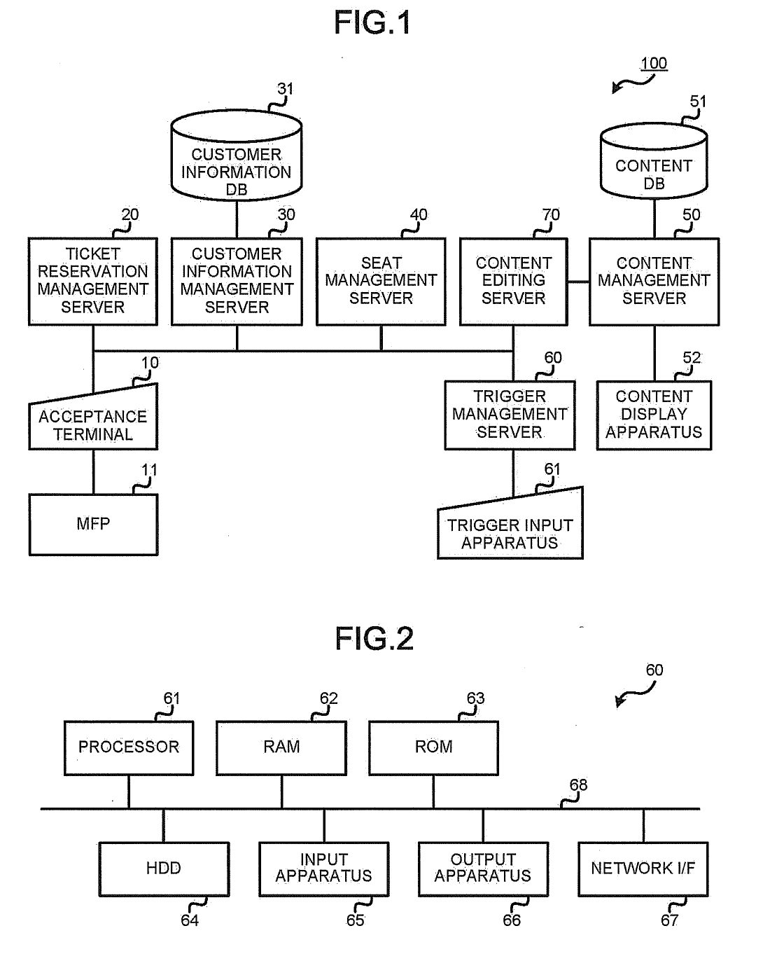

Hereinafter, the embodiment is described with reference to accompanying drawings. FIG. 1 is a block diagram illustrating a configuration example of a releasing system 100 in the present embodiment. An acceptance terminal 10 is a terminal configured in the cinema carrying out various services or information processing by the operation of the user himself or an operator. The acceptance terminal 10 is connected with an MFP 11 (MFP: Multifunctional Peripheral) which as an image forming apparatus. The MFP 11 carries out printing-oriented image processing or printing processing controlled by an application carried on the acceptance terminal 10.

A ticket reservation management server 20 is a server managing the reservation information and the purchase information of a movie ticket. The reservation and the purchase of the ticket are carried out from the acceptance terminal 10, and the ticket is issued by the MFP 11. In addition, the “management” in the present embodiment refers to the operation of the retention or the retrieval of the information and the login or the update and the cancellation of new information, indicated all functions which can be carried out by a conventional data base system (hereinafter, called as DB).

A customer information management server 30 is a server managing the personal information of the user. The customer information management server 30 carries out the control of inputting and outputting data on a customer information DB (31), and the customer information of the movie audience is stored in the DB. The customer information in the present embodiment is the personal information of the customer which are previously membership registered comprises one portion or all of the name, the age, the birthdate, the address, the Email address and the like of the customer. The membership registration can be also carried out when the ticket is purchased.

A seat management server 40 is a server managing the seat information of the cinema. Seats are respectively equipped with the trigger input apparatuses 61, and the seats and the trigger input apparatuses have one-to-one correspondence relations. The seat management server 40 manages the data that a seat number corresponds to the number of the trigger input apparatus and the data that the customer information reserved by using the ticket reservation management server 20 corresponds to the seat number.

A content management server 50 is a server distributing the released movie (content). The content management server 50 carrying out the control of inputting and outputting data on content DB 51, acquires the released content from the content DB 51, and outputs it to a content display apparatus 52. The content display apparatus 52 provides the content for the user in a cinema comprises a large screen releasing the image, a speaker outputting the sound, and the like.

A trigger management server 60 is a server managing the trigger information input by the trigger input apparatus 61 and the time acquired by the trigger information by each trigger input apparatus 61, and in addition, is a server carrying out totalizing processing.

The trigger input apparatus 61 comprising a push type button mounted on each seat, output a signal (trigger information) to the trigger management server 60 when the button is pressed down. The trigger input apparatus 61 is set as an apparatus with the physical button arranged on the seat in the present embodiment, can be also realized to be an implementation that transmits a telegram (trigger information) to the trigger management server 60 by operating the button of the portable communication terminal (an apparatus which can transmit and receive data with the exterior, such as a mobile phone or a smart phone and the like) which installed with the designated application. In such a case, the trigger input apparatus 61 becomes a communication terminal.

A content editing server 70 is a server carrying out cutout processing on the content looked and listened by the user based on the trigger information input by the user. The user selects the cutout content generated in the content editing server 70 through the acceptance terminal 10, and the MFP 11 provides the printed sheet on which the cutout content is printed for the user. In addition, the sheet is assumed to be a paper medium, but also can be the sheet made of plastic or fabric (for example, the printing is carried out on a shirt and the like).

In addition, an example that the customer information DB 31 is configured in the customer information management server 30 and the content DB 51 is described as a substance configured in the content management server 50, but the function of a DB system of the exterior can also be transferred.

FIG. 2 is a block diagram illustrating a hardware configuration example of the server. Internal configurations of the trigger management server 60 are taken for example for description in FIG. 2, but other servers 20-70 also have the same configurations. In addition, in the present embodiment, the acceptance terminal 10 also has the same configurations.

The trigger management server 60 comprises a processor 61 as an arithmetic processing apparatus for a CPU (Central Processing Unit) or an MPU (Micro Processing Unit) and the like, an RAM (Random Access Memory) 62 as a volatile storage apparatus, an ROM (Read Only Memory) 63 as a readout dedicated storage apparatus and an HDD (Hard disk drive) 64 as a non-volatile storage apparatus. In addition, the trigger management server 60 also comprises an input apparatus 65 such as a keyboard, a mouse and the like, an output apparatus 66 such as a monitor and the like, and a network I/F (I/F: Interface) 67 controlling the communication with an external device. All the apparatuses mutually carry out the reception and the transmission of the data or the signal by a bus 68. Hardware configurations are the same as the configurations of a computer, and therefore, detailed description is omitted. An input apparatus and an output apparatus of the acceptance terminal 10 can be also touch panel display, and the server can be also a structure without the input apparatus or the output apparatus.

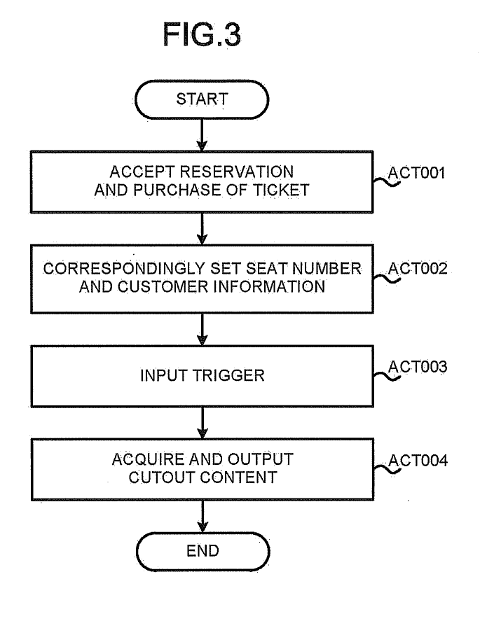

FIG. 3 is a flow chart illustrating an action example of the whole system until when the cutout content is acquired after the movie is looked and listened by the user. Each processing in the following flow chart is realized by the cooperation of each hardware stored in each sever and the acceptance terminal 10 together with the arithmetic execution by loading a program previously introduced into the HDD in the RAM by the processors in each server and the acceptance terminal 10.

First, the acceptance terminal 10 configured in the cinema accepts the reservation and the purchase of the release ticket from the user (ACT001), and inquires the ticket reservation management server 20 about the vacancy status of the movie. The ticket reservation management server 20 confirms the existence of a vacancy for the movie when the inquiry is received from the acceptance terminal 10, and in the case that the vacancy exists, the ticket reservation management server 20 acquires the seat information of the movie from the ticket management server 40, and transmits the seat information of the movie to the acceptance terminal 10. The user determines his seat number by designating the random seat from the vacant seats displayed on the acceptance terminal 10.

In addition, in the case that the customer information of the user is previously registered, the acceptance terminal 10 correspondingly sets the seat number and the customer information by acquiring a customer ID (ID: Identification) (ACT002). The customer ID can be directly input by the user, or acquired by reading an ID card held by the user in the case that a card reader and the like are arranged in the acceptance terminal 10. The seat number and the customer ID are transmitted to the seat management server 40 in a set manner, and correspondingly managed by the seat management server 40.

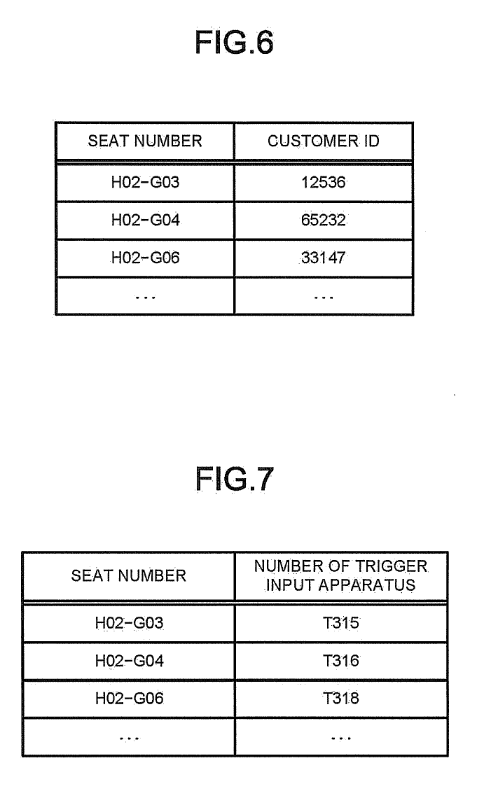

An example that the seat number and the customer ID are correspondingly set is illustrated in FIG. 6. The seat number is the combination of a hall number (for example, “H02”) of the cinema and the seat number (for example, “G03”) in a screening hall. In addition, as shown in FIG. 7, the seat number and the number of the trigger input apparatus are correspondingly and previously set one to one in the seat management server 40, and according to correspondence information illustrated in these FIG. 6 and FIG. 7, any trigger input apparatus being used by any customer can be derived.

Next, besides sitting on the reserved seat in the screening hall the user uses the trigger input apparatus 61 mounted on the seat to input the trigger information when an interested scene appears during the movie watching process (ACT003). In the cinema, if the prompt of the content, for example, “if interested scene exists, please press down the button of the seat” exists, the propaganda can be carried out on the user who does not understand the system.

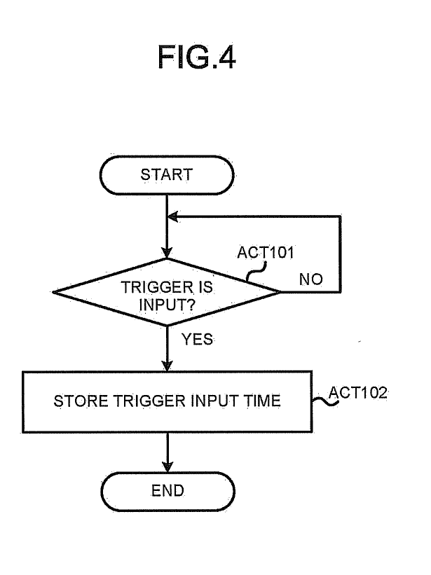

FIG. 4 is a flow chart of trigger input processing. The network I/F 67 of the trigger management server 60 receives the trigger information at anytime from the trigger input apparatus 61 in a screening process (ACT101, loop of No). In the case that the information is received from the trigger input apparatus 61 in the screening process (Yes in ACT101), the processor 61 of the trigger management server 60 acquires the time that acquired in a network I/F 27 by trigger information from an own system clock (or acquires the time from an external server), and correspondingly stores the accumulative occurrence number of times (trigger count) of trigger in the HDD 64 (ACT102).

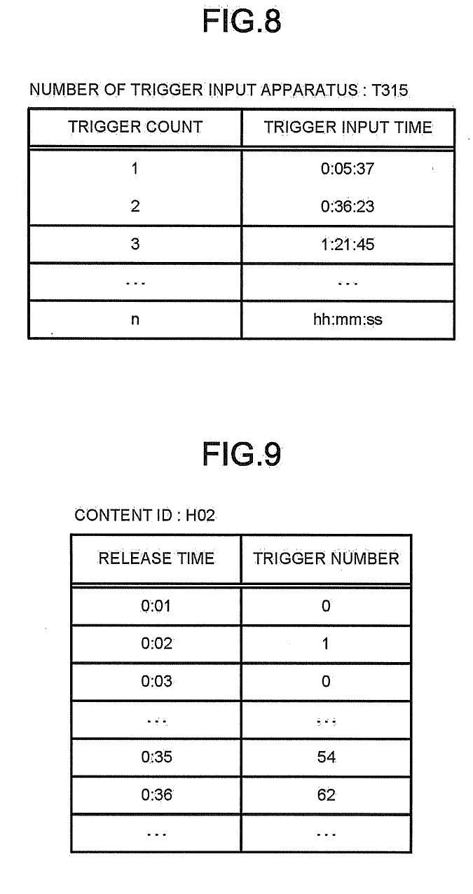

FIG. 8 is a diagram illustrating the information stored in the HDD64 of the trigger management server 60. The trigger management server 60 correspondingly stores the trigger count denoting that the present input is the input of which time and the time information (trigger input time) of an input timing. The corresponding information illustrated in FIG. 8 exists in each trigger input apparatus 61, and able to manage that whether or not any user inputs the trigger at any timing. The trigger input time is set as the play time of the content or a current timing, in the case that the start time of screening is determined. The trigger is input, at the timing when the user intends to retain, for example, an impressive scene, a meaningful scene and the like in the movie as the content subsequently.

It is returned to the flow chart in FIG. 3. After the movie appreciation, the acquirement of the cutout content and the output of the sheet in ACT004 are started by carrying out a prescribed operation on the acceptance terminal 10 by the user (or the operator). The content editing server 70 executes the editing and generation processing of the cutout content of the user being operated by the acceptance terminal 10, and the MFP 11 outputs the generated cutout content by printing them on a sheet (ACT004).

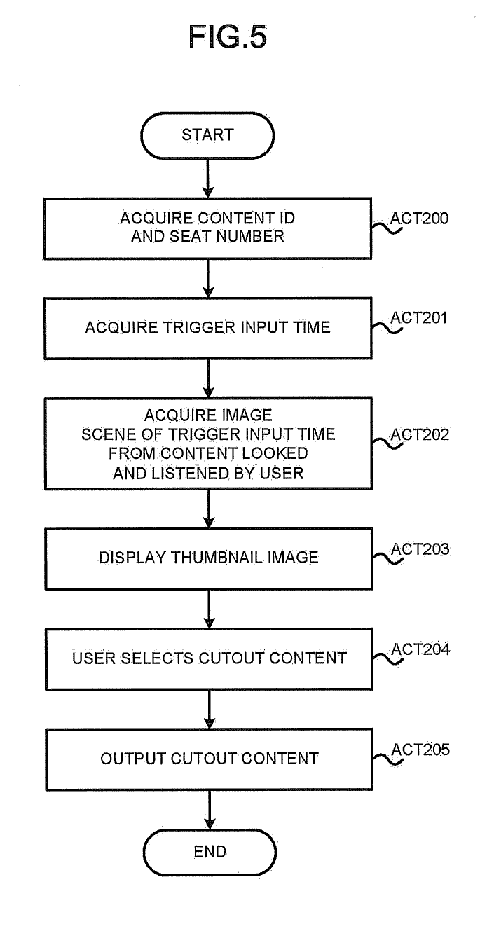

FIG. 5 is a flow chart acquiring and outputting the cutout content. The content editing server 70 receives a content ID, the seat number from the acceptance terminal 10 (ACT200) together with a prescribed instruction message. The content ID, for example, is the hall number (for example, “H02”) in the screening hall, recorded on the stub of a ticket together with the seat number (for example, “G03”). The user inputs a necessary item by operating the acceptance terminal 10 while confirming the stub of a ticket. In addition, in the case that the user already completed the membership registration, the content ID and the seat number can be acquired just by inputting the customer ID based on the correspondence information in FIG. 6.

The content editing server 70 uses the correspondence information in FIG. 7 to acquire the number of the trigger input apparatus from the seat number, and acquires the trigger input time (referring to FIG. 8) of the trigger input apparatus from the trigger management server 60 (ACT201).

The content editing server 70 acquires the scene of the trigger input time from the content looked and listened by the user (ACT202). ACT202 is described. The content editing server 70 transmits the content ID transmitted from the acceptance terminal 10 to the content management server 50. The content management server 50 utilizes the transmitted content ID to retrieve the content DB 51, and returns content data acquired by the retrieval to the content editing server 70. The content editing server 70 acquires the cutout content (in the present example, the static image) corresponding to the trigger input time in the screened scene of the received data content. In the case that the trigger input time, for example, is 1 hour, 21 minutes and 45 seconds, the content editing server 70 cuts out the static image after 1 hour, 21 minutes and 45 seconds from the start of the regeneration of the content, so as to acquire the static image. In the case that the number of the trigger input times is multiple, the static image of the content is acquired as the number of the trigger input time. In addition, as the fuzziness possibly occurs in the image acquired by the trigger input time, the implementation can also be realized by, for example, preparing static image previously in a minute unit and acquiring the prepared static image of which the time approaches the trigger input time as the cut content.

The content editing server 70 carries out the contraction and the thumbnail of the acquired cutout content and transmits it to the acceptance terminal 10. The identification number respectively marked in the thumbnail image is also transmitted to the acceptance terminal 10.

The acceptance terminal 10 carries out summary display of the acquired thumbnail image (ACT203). The user selects the anticipant scene which printed out as the selected cutout content by the MFP 11 (ACT205) from the summary table of the thumbnail image (ACT204).

The details of the actions from ACT203 to ACT205 are described. The acceptance terminal 10 waits until the thumbnail image displayed in a button form is selected by the user. When the user selects one or a plurality of thumbnail images from the summary table and presses down a determination button, the acceptance terminal 10 transmits the identification number corresponding to the selected thumbnail image to the content editing server 70. The content editing server 70 receives the identification number and returns the cutout content corresponding to the identification number to the acceptance terminal 10.

The acceptance terminal 10 receives the cutout content and carries out the printout instruction of the cutout content on the MFP 11. Thus, the image of the cutout content is formed on the sheet and is provided for the user. In such a case that the content belongs to a sheet medium, the scene that the user intends to see again can be also output in a poster form or a pamphlet form according to a previously prepared layout. The Layout data can be also set previously prepared with a plural number, so that the user can select from.

In addition, the output can be also transmitted to a tablet PC, the communication terminal and the like in an electronic data manner by using a wireless communication unit. In such a case, the acceptance terminal 10 comprises a wireless communication device by which the electronic data are transmitted consistent with a short-distance wireless communication specification. In addition, in the case that the Email address is registered in member information, the electronic data can be also transmitted by using an Email. In such a case, the network I/F67 of the trigger management server 60 which comprises an Email transmission function transmits the electronic data in an Email form. In the case that it is transmitted in the electronic data manner, not only can the static image be transmitted, but also animation and sound information, of one portion of the content which is cut out, can be also transmitted. In the case that the animation and sound information is transmitted, the animation and sound information, for example, ten seconds (20 seconds in total) before and after the trigger input time is cut out and is provided for the user. Any one or both of the provision realized by utilizing the sheet medium or the provision realized by utilizing the electronic data can be implemented.

The trigger input apparatus 61 can be also continuously pressed for many times within a short time when the scene and the like in which the user is quite interested. The trigger management server 60 can quantitatively acquire the extent of the interest of the user by counting the pressing number of times within a short time. In addition, the trigger input apparatus 61 can be also persistently pressed for a relatively longer time. The implementation also can be realized by storing the start time and the stop time in the trigger management server 60 and deriving the start and end timings of cutout when the cutout content is the animation or sound information based on the start time and the stop time of trigger.

Without distinction of being charged or not, the cutout content can be provided. In addition, the implementation also can be realized to be that a fee is charged additionally in the case that the number of the printed sheet exceeds a certain quantity.

By the configurations as described above, the favor and the emotion of the user and the moment intended to be retained are reflected in the content in a trigger form, and thus, after the customer watches the content, the further enjoyable content can be provided for the user.

On the other hand, the trigger management server 60 totals the number of the trigger for each time after the screening based on the acquired trigger input time. The trigger management server 60, for example, as shown in FIG. 9, totalizes a trigger number of incidents in minutes for the content. Thus, the number of the trigger in any one time period is known, and by correspondingly setting the trigger and the releasing screen of the content, whether or not some screen acquires the attention of the user can be confirmed. The totalizing process is carried out by the processor 61 of the trigger management server 60.

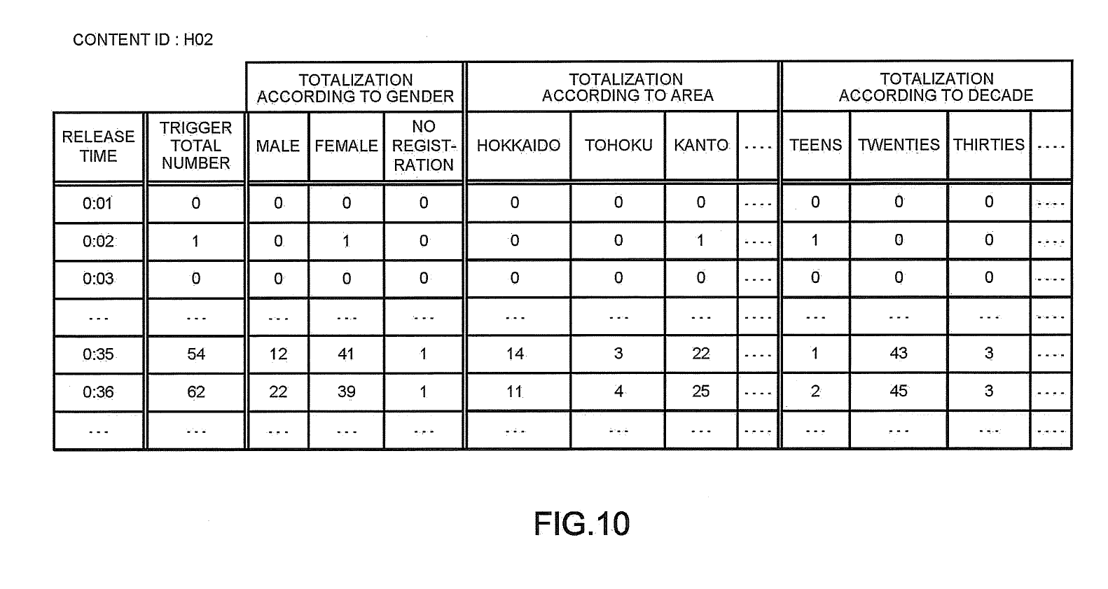

In addition, for the user whose customer information is logged in, the customer ID and the number of the trigger input apparatus are set correspondingly (referring to FIG. 6 and FIG. 7), and therefore, the trigger input time in FIG. 8 can be even learned by utilizing the customer ID. Therefore, any scene in which any user is interested is learned, and moreover, from the age, the address, the gender and the like as the login information of the user, as exemplified in FIG. 10, various totalizations for each of the decade, the area and the gender can be acquired. The trigger management server 60 utilizes a category (the information related to the user) such as the age, the address, the gender and the like to further distinguish a trigger total number for each time, and carries out totalizing according to the category.

For the user who does not carry out the membership registered, in the present embodiment, it is processed as other totalization (referring to the “not logged in” in FIG. 10), and the implementation also can be realized to have nothing to do with the totalization to be removed. In addition, the category such as the decade, the area, the gender and the like is only one example, for example, if it is the category of the personal information logged in by the user, such as a profession category, a blood type and the like, the totalization can be carried out with any distinguishing. In addition, not only can the customer information be used as a totalizing category, for example, a front seat, a back seat, a left seat, a right seat and the like, and the position of the seat in the hall when the movie is watched, but also the release variety even belongs to the same movie such as an English version, a Japanese subtitle version, a 2D version, a 3D version and the like can be used as the category to carry out the totalizing.

For example, for the portion that the data and the like frequently generated by the trigger information are quite obviously considered as noise data, the totalizing is carried out after removing the noise data. In addition, totalizing values illustrated in FIG. 9 and FIG. 10 are values after the trigger generation number for each time is directly accumulated (counted), but as the trigger generation number is changed according to the number (parameter) of the user looking at and listening to the movie, a proportion can be also used as the totaling value. For example, in the case illustrated in FIG. 9, a value obtained by dividing the trigger number by the number of the user carrying out the looking and listening can be also used as the totalizing value. The “totalizing” does not just accumulate the number of the trigger information simply, and moreover, also includes arithmetic processing such as the calculation and the like of the proportion. The arithmetic processing (totalizing method) in a totaling process has various methods.

In the present embodiment, the processing is carried out by using a plurality of frames for each function, but a hardware structure and the sharing structure of the function are not limited to that. The processing shared by one frame can be also dispersed in the plurality of frames, and the processing dispersed in the plurality of frames to be executed can be also integrated in one frame. The processing described above can be also integrated in one frame.

Besides the above embodiment, the implementation can be also carried out in a place enjoying entertainment, such as a live show venue, a television in a parlor, and the like, moreover, the content corresponding with the interest of the user can be generated from a live content or a television content is immediately provided for the user, and the totalizing is carried out. In addition, not only can the manner of the present embodiment be applied in a screening case, but also can be applied in a case that music is broadcasted.

The time data collection system corresponds to the screening system 100. The storage unit corresponds to the trigger management server 60 (a structure including the HDD 64), and the reception unit corresponds to the trigger management server 60 (a structure including the network I/F 67). The control unit corresponds to the trigger management server 60 (a structure including the processor 61).

A content cutout unit corresponds to the content editing server 70, and the supply unit corresponds to the acceptance terminal 10 (a structure including the wireless communication device), the MFP 11 and the trigger management server 60 (a structure including the Email transmission function and the network I/F67). A user information storage unit corresponds to the customer information DB 31. A first apparatus corresponds to the trigger input apparatus 61.

As described above in detail, according to a technology recorded in the present specification, the time when the audience carries out information transmission in the process that the content is being looked and listened can be acquired, and thus, it can expect to be capable of learning the scene and a melody in which the audience is interested in the looked and listened content.

In the present embodiment, the case that the function implementing the present embodiment previously recorded inside the apparatus is described, but is not limited to that, the same function can be also loaded in the apparatus from a network, or a device storing the same function in a recording medium can be also mounted As the recording medium, so long as the recording medium can store the program, such as a CD-ROM and the like, and furthermore, is apparatus-readable, the form of the recording medium can be any form. In addition, the function can be also realized by the function acquired by being previously installed or loaded in such a manner synergistically acting with an OS (operating system) and the like inside the apparatus.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A time data collection system, comprising:
a storage unit;
a reception unit configured to receive an information input by a user in a process that the user is looking at and listening to content; and
a control unit configured to accumulate time data of when the information is received in the reception unit and store the time data in the storage unit.

2. The time data collection system according to claim 1, further comprising:
a content cutout unit configured to acquire the cutout data of a position corresponding to the time from the data of the content; and
a supply unit configured to provide the cutout data acquired by the content cutout unit for the user in a manner of printing the cutout data on a sheet and/or a manner of transmitting the cutout data in an electronic data form.

3. The time data collection system according to claim 1, wherein
in a case that a plurality of users are looking at and listening to the content,
the reception unit receives the information for each user; and
the control unit totals the number of the transmission times of the information for each time based on the time data of when the information is received in the reception unit.

4. The time data collection system according to claim 3, further comprising:
a user information storage unit configured to store the information related to the user looking at and listening to the content, wherein
the control unit distinguishes a value totaled for each time into the information related to the user and totals the result of the division.

5. The time data collection system according to claim 1, wherein
the content is a movie; and further comprising:
a first apparatus configured to be arranged on each seat in a hall screening the movie and transmit the information to the reception unit by the operation of the user who is looking at and listening to the movie.
